(19) United States
(12) Patent Application Publication
(10) Pub. No.: US 2014/0011968 A1
(43) Pub. Date: Jan. 9, 2014

(54) COMPOSITION FOR ARAMID AND ARAMID PRODUCT MANUFACTURED USING THE SAME

(71) Applicants: In Sik Han, Daegu (KR); Jae Young Lee, Daegu (KR)

(72) Inventors: In Sik Han, Daegu (KR); Jae Young Lee, Daegu (KR)

(73) Assignee: KOLON INDUSTRIES, INC., Gwacheon-si, Gyeonggi-do (KR)

(21) Appl. No.: 14/000,965

(22) PCT Filed: Apr. 6, 2012
(86) PCT No.: PCT/KR12/02651

§ 371 Date: Sep. 20, 2013

(30) Foreign Application Priority Data
Apr. 8, 2011 (KR) 10-2011-0032664

(51) Int. Cl. C08L 77/00

(52) U.S. Cl. CPC C08L 77/00
USPC 525/461

(57) ABSTRACT

Disclosed is an aramid product in which the number of defects present in noncrystalline regions is considerably reduced and a composition for aramid for producing the same. The composition contains aromatic polyamide and a fused aromatic compound, wherein the content of the fused aromatic compound is 0.01 to 10 parts by weight, based on 100 parts by weight of the aromatic polyamide.

### TECHNICAL FIELD

The present invention relates to a composition for aramid and an aramid product manufactured using the same.

### BACKGROUND ART

Generally, wholly aromatic polyamide also known as “aramid” includes para-type wholly aromatic polyamide having a structure in which benzene rings are linearly linked through an amide group (CONH) and meta-type wholly aromatic polyamide having no such a structure.

In particular, aramid fibers prepared using para-typewholly aromatic polyamide have superior properties such as high strength, high modulus, low contraction, and in particular, have a remarkably high strength, enabling a 2 ton vehicle to be lifted using thin threads having a thickness of about 5 mm and are thus used for bullet-proof applications as well as various applications in the high-tech industry such as aerospace. In addition, aramid fibers are carbonized at 500° C. or higher and are in the spotlight in the field requiring high heat resistance too.

Such an aramid fiber is commonly prepared by a method including polymerizing aromatic diamine and aromatic diacid halide in a polymerization solvent containing N-methyl-2-pyrrolidone to prepare a wholly aromatic polyamide polymer, dissolving the polymer in concentrated sulfuric acid as a solvent to prepare a spinning dope, spinning the spinning dope through a spinneret and solidifying the same to prepare a filament, and washing and drying the filament.

However, the aramid products are low in terms of physical properties such as tensile strength since many defects are present in noncrystalline regions thereof. That is, when external force is applied to aramid products such as aramid fibers, stress is concentrated in defective noncrystalline regions and the aramid fibersare thus readily cut. Disadvantageously, aramid products with deteriorated physical properties cannot be used in various fields requiring high qualities.

### DISCLOSURE OF INVENTION

### Technical Problem

Therefore, the present invention is directed to a composition for aramid and an aramid product produced using the same to solve the problems caused by the limitations and drawbacks of the related art.

It is one aspect of the present invention to provide a composition for aramid capable of considerably reducing the number of defects present in noncrystalline regions of aramid products.

It is another aspect of the present invention to provide an aramid product, in which the number of defects present in noncrystalline regions is considerably reduced.

In addition to the aspects described above, other aspects and characteristics of the present invention will be described below, or will be clearly understood by those having a common knowledge in the art from the description.

### Solution to Problem

In accordance with one aspect of the present invention, provided is a composition for aramid containing: aromatic polyamide; and a fused aromatic compound, wherein the content of the fused aromatic compound is 0.01 to 10 parts by weight, based on 100 parts by weight of the aromatic polyamide.

In accordance with another aspect of the present invention, provided is an aramid product containing: aromatic polyamide; and a fused aromatic compound dispersed in the aromatic polyamide, wherein the content of the fused aromatic compound is 0.01 to 10 parts by weight, based on 100 parts by weight of the aromatic polyamide.

### Advantageous Effects of Invention

The composition for aramid according to the present invention comprises aromatic polyamide as well as an additive capable of effectively interacting with the aromatic polyamide in which the additive is homogeneously dispersed. Accordingly, aramid products produced from the composition have almost no defect in the noncrystalline regions thereof, thus exhibiting superior physical properties. By virtue of such superior physical properties, the aramid products of the present invention may be used in a variety of fields such as bulletproof clothes, bulletproof helmets, airplanes, and so on.

### MODE FOR THE INVENTION

Hereinafter, the present invention will be described in more detail.

Those skilled in the art will appreciate that various modifications, additions and substitutions are possible, without departing from the scope and spirit of the invention as disclosed in the accompanying claims. Accordingly, the present invention includes the inventions as defined in the claims and the variations thereof as well that fall within the scope of equivalents of the claimed invention.

In this specification, the term “fused aromatic compound” should be understood to include fused polycyclic aromatic compounds and fused heteropolycyclic aromatic compounds. The term “fused polycyclic aromatic compound” refers to a fused aromatic compound including fused rings having only carbon atoms. The term “fused heteropolycyclic aromatic compound”refers to a fused aromatic compound in which at least one of the carbon atoms constituting the fused rings is substituted by another atom.

Hereinafter, the composition for aramid and the aramid product manufactured using the same according to the present invention will be described in detail.

The composition for aramid of the present invention comprises aromatic polyamide. The aromatic polyamide may be prepared in accordance with the following process.

First, an inorganic salt is added to an organic solvent to prepare a polymerization solvent.

Subsequently, aromatic diamine is dissolved in the polymerization solvent to prepare a mixed solution. The aromatic diamine may be a substituted or unsubstituted aromatic diamine.

Examples of the unsubstituted aromatic diamine include para-phenylenediamine, 4,4′-diaminobiphenyl, 2,6-naphthalenediamine, 1,5-naphthalenediamine and 4,4′-diaminobenzanilide. The substituent in the substituted aromatic diamine may be CN, Cl, Br, I, NO₂, and/or an alkyl or alkoxy group having 1 to 10 carbon atoms.

Subsequently, aromatic diacid halide is added to the mixed solution to prepare a pre-polymer. That is, the pre-polymer may be prepared by adding a predetermined amount of aromatic diacid halide to the mixed solution while the solution containing the aromatic diamine is stirred.

Meanwhile, the amount of the aromatic diacid halide used for preparation of the pre-polymer is preferably 20 to 50 mol % of the total amount of the aromatic diacid halide required for preparation of the aromatic polyamide.

The aromatic diacid halide may be substituted or unsubstituted aromatic diacid halide.

The unsubstituted aromatic diacid halide may be terephthaloyl dichloride, 4,4′-benzoyl dichloride, 2,6-naphthalene dicarboxylic acid dichloride, 1,5-naphthalenedicarboxylic acid dichloride or the like.

Then, aromatic diacid halide is further added to the pre-polymer at a temperature of 0 to 30° C. to obtain the aromatic polyamide.

The aromatic polyamide thus obtained may be, for example, poly(paraphenylene terephthalamide)(PPDT), poly(4,4′-benzanilide terephthalamide), poly(paraphenylene-4,4′-biphenylene-dicarboxylic acid amide), or poly(paraphenylene-2,6-naphthalenedicarboxylic acid amide).

Subsequently, an acid produced during the polymerization is neutralized with an alkali compound. And then, the processes for extraction, washing, grounding, and drying are performed to yield a final aromatic polyamide. The aromatic polyamide thus prepared has a strong molecular structure, thus exhibiting high strength and high heat resistance.

The composition for aramid of the present invention further comprises, in addition to the aromatic polyamide thus prepared, a fused aromatic compound capable of interacting with the aromatic polyamide.

The fused aromatic compound has a plurality of aromatic rings and is capable of easily interacting with the aromatic rings constituting the aromatic polyamide. That is, π-π interaction readily occurs since the aromatic ring of the fused aromatic compound has a similar structure to the aromatic ring of the aromatic polyamide. Although the bonding force itself based on π-π interaction is not that strong, the entire bonding force becomes strong as the π-π interaction accumulates.

As such, an aramid product containing the fused aromatic compound capable of π-π interaction can exhibit considerably improved physical properties since the number of the defects in the noncrystalline regions is significantly low due to the π-π interaction.

In order to secure sufficient π-π interaction, the content of the fused aromatic compound should not be less than 0.01 parts by weight, based on 100 parts by weight of the aromatic polyamide.

Meanwhile, according to the present invention, the content of the fused aromatic compound is not more than10 parts by weight, based on 100 parts by weight of the aromatic polyamide. The reason for this is that, when the content of the fused aromatic compound exceeds 10 parts by weight, the strength of an aramid product is deteriorated due to the phase separation of the fused aromatic compound.

The fused aromatic compound may have 2 to 10 aromatic rings. When the number of aromatic rings of the fused aromatic compound is lower than 2, interaction between the fused aromatic compound and the aromatic polyamide may decrease. On the other hand, when the number of aromatic rings of the fused aromatic compound exceeds 10, interaction between the fused aromatic compound and the aromatic polyamide may be deteriorated due to the interactions between the fused aromatic compounds, and the fused aromatic compounds cannot be dispersed homogeneously in the noncrystalline regions of the aromatic polyamide, which makes the remarkable reduction of the defects in the noncrystalline regions impossible.

The fused aromatic compound of the present invention comprises at least one of a fused polycyclic aromatic compound and a fused heteropolycyclic aromatic compound.

The fused polycyclic aromatic compound comprises at least one selected from naphthalene, anthracene, phenanthrene, and derivatives thereof, and the fused heteropolycyclic aromatic compound comprises at least one selected quinoline, isoquinoline, indole, purine, porphyrin, and derivatives thereof.

The fused aromatic compound of the present invention may contain a functional group capable of forming a hydrogen bond with the aromatic polyamide. That is, the fused aromatic compound of the present invention may have a functional group capable of forming a hydrogen bond with oxygen and nitrogen constituting an amide bond of the aromatic polyamide. Although a hydrogen bond itself may not be particularly strong, the entire interaction therebetween may be increased if a plurality of hydrogen bonds are combined.

Since an aramid product of the present invention containing the fused aromatic compound that can form a hydrogen bond with the aromatic polyamide has strong interaction between aromatic polyamide and the fused aromatic compound through the hydrogen bond, there are little defects in the noncrystalline regions and physical properties such as tensile strength may be greatly improved.

The functional group may be selected from the group consisting of —COOH, —NH₂, —OH, —SO₃H, —SO₂NH2,—CONH₂, —SH, and aromatic or aliphatic derivatives containing —O—, —NH—, or —S—. The fused aromatic compound containing the functional group is hydrogen-bonded or ionically bonded to the aromatic polyamide, thus greatly decreasing the defects in the noncrystalline regions of the aramid products.

According to an exemplary embodiment of the present invention, the fused aromatic compound comprises a dioxoanthracene derivative represented by the following formula:

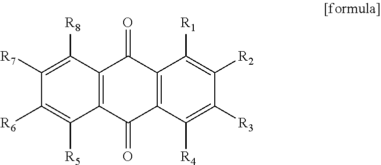

wherein each of R1 to R8 is independently a hydrogen atom, a substituted or unsubstituted alkyl group, a substituted or unsubstituted aryl group, a substituted or unsubstituted heterocyclic group, or a functional group capable of forming a hydrogen bond with the aromatic polyamide.

Preferably, at least one of R1 to R8 is a functional group capable of forming a hydrogen bond with the aromatic polyamide, and the functional group is selected from the group consisting of —COOH, —NH₂, —OH, —SO₃H, —SO₂NH₂, —CONH₂, —SH, and aromatic or aliphatic derivatives containing —O—, —NH—, or —S—.

Since the dioxoanthracene derivatives have three fused rings only, they favorably interact with aromatic polyamide, rather than interact with themselves and are readily permeated into the noncrystalline regions of the aramid products. In addition, the dioxoanthracene derivatives can induce π-π interaction with aromatic polyamide, thus decreasing defects in the noncrystalline regions of the aramid products.

Meanwhile, the dioxoanthracene derivatives contain one to eight functional groups that form a hydrogen bond with aromatic polyamide, thus forming sufficient hydrogen bonds with the aromatic polyamide, greatly interacting with aromatic polyamide and thereby decreasing defects of noncrystalline regions in the aramid product.

In order to produce aramid products using the compositions for aramid, it is necessary to dissolve the composition for aramid in a solvent. The solvent should dissolve both the aromatic polyamide and the fused aromatic compound.

When the aromatic polyamide has a para-structure, 95% or more of concentrated sulfuric acid may be used as a solvent. That is, since aromatic polyamide having a strong aromatic structure is not well soluble in a common organic solvent such as N-methyl-2-pyrrolidene, a solvent such as concentrated sulfuric acid, chlorosulfuric acid, or fluorosulfuric acid should be used.

On the other hand, when the aromatic polyamide has a meta-structure or a copolymer containing a soft repeating unit, a common organic solvent may be used. For example, such an organic solvent is N-methyl-2-pyrrolidone (NMP), N,N′-dimethylacetamide (DMAc), hexamethylphosphoamide (HMPA), N,N,N′,N′-tetramethyl urea (TMU), N,N-dimethylformamide (DMF) or a mixture thereof.

Since the fused aromatic compound and the aromatic polyamide are homogeneously dissolved in a solvent, aramid products produced from this solution contain a fused aromatic compound homogeneously dispersed in the aromatic polyamide. As a result, interaction between aromatic polyamide and the fused aromatic compound is superior and physical properties such as tensile strength of aramid products are greatly improved.

Next, aramid products according to one embodiment will be described in detail.

The aramid product of the present invention is produced using the composition for aramid. That is, the aramid product is produced by dissolving the composition for aramid in an appropriate solvent and curing the resulting solution into a predetermined shape using a molding machine such as a mold, spinneret, extruder, or dispenser.

Accordingly, the aramid product of the present invention includes aromatic polyamide and a fused aromatic compound dispersed in the aromatic polyamide.

The aromatic polyamide may be para-type aromatic polyamide. The para-type aromatic polyamide has linearly arranged aromatic rings, thus maximizing π-π interaction with the fused aromatic compound. Since aromatic rings are linked to one another through amide groups, aromatic polyamide can form a hydrogen bond with the fused aromatic compound. Accordingly, by using para-type aromatic polyamide, physical properties of aramid products can be further improved.

The aromatic polyamide may be meta-type aromatic polyamide. The aromatic polyamide favorably interacts with a fused aromatic compound and thus improves physical properties of aramid products, since the meta-type aromatic polyamide contains aromatic rings and the aromatic rings are linked to one another through an amide group.

The aramid product of the present invention contains a fused aromatic compound homogeneously dispersed in aromatic polyamide, since it is produced using the solution obtained by homogeneously dissolving aromatic polyamide and a fused aromatic compound in a solvent. As a result, defects in noncrystalline regions are considerably reduced and improved physical properties are imparted to the aramid product.

Although the aramid product of the present invention may be one other than a fiber, which has a film, sheet, rod or spherical shape, an aramid product having a fibrous shape, i.e., an aramid fiber, will be described in detail as an example.

The aramid fibers according to one embodiment of the present invention will be prepared in accordance with the following process.

First, the composition for aramid of the present invention is dissolved in concentrated sulfuric acid to prepare a spinning dope. Subsequently, the spinning dope is spun using a spinneret. The spinning dope squeezed out from the spinneret passes through an air gap and a coagulation liquid in this order and is then coagulated. As a result, the spinning dope becomes a filament.

The coagulation bath containing the coagulation liquid is disposed at a lower part of the spinneret. A coagulation tube is provided at the lower part of the coagulation bath and the filament passes through the coagulation tube.

Subsequently, sulfuric acid present in the filament thus obtained is removed. Since concentrated sulfuric acid is used for preparation of spinning dope, sulfuric acid may remain in the filament prepared by the aforementioned spinning process. Sulfuric acid that remains in the filament may be removed by washing using water, or a mixture of water and an alkali solution.

Subsequently, the filament is dried to control water content thereof and is thermally treated to stabilize the internal structure thereof.

Subsequently, the thermally treated filament is wound on the core mounted on a winder to yield an aramid fiber.

The aramid fiber according to one embodiment of the present invention contains aromatic polyamide and a fused aromatic compound, wherein the content of the fused aromatic compound is 0.01 to 10 parts by weight, based on 100 parts by weight of the aromatic polyamide. When the content of the fused aromatic compound is lower than 0.01 parts by weight, defects present in noncrystalline regions of aramid fibers cannot be sufficiently decreased and tensile strength cannot be improved. On the other hand, when the content of the fused aromatic compound exceeds 10 parts by weight, the content of fused aromatic compound is excessive, crystalline regions are greatly decreased, a decrease of crystalline regions, as a negative effect, surpasses a decrease of defects in crystal regions, as a positive effect. As a result, tensile strength of aramid fibers is decreased.

The aromatic polyamide contained in aramid fibers of the present invention may be para-aromatic polyamide. In this case, the aramid fibers have a tensile strength of 28 to 35 g/d (which is 8% or more higher than conventional para-aromatic polyamide fibers) and an elongation of 3.5 to 4.0% (which is 3% or more higher than conventional para-aromatic polyamide fibers). The aramid fibers having superior tensile strength and elongation of the present invention may be used in various fields including bulletproof clothes, bulletproof helmets, airplanes and the like.

Now, the present invention will be described in more detail with reference to the following examples. These examples are only provided to illustrate the present invention and should not be construed as limiting the scope and spirit of the present invention.

### EXAMPLE 1

CaCl₂ was added to N-methyl-2-pyrrolidone(NMP) to prepare a polymerization solvent and para-phenylenediamine was dissolved in the polymerization solvent to prepare a mixed solution.

Then, the mixed solution was stirred, and terephthaloyl dichloride at moles equivalent to the para-phenylenediamine was divided into two aliquots and was added to the mixed solution to prepare a poly(paraphenylene terephthalamide) polymer. Then, water and NaOH were added to the polymer solution containing the polymer to neutralize the acid. Then, the polymer was ground, the polymerization solvent contained in the aromatic polyamide polymer was extracted with water, and the residue was dehydrated and dried to yield aromatic polyamide as a final product.

N-(4-amino-3-methoxy-9,10-dioxoanthracen-1-yl)-4-methylbenzenesulfoamide was added to the aromatic polyamide thus obtained to prepare a composition for aramid. The content of N-(4-amino-3-methoxy-9,10-dioxoanthracen-1-yl)-4-methylbenzenesulfoamide was 1% by weight, based on the weight of the aromatic polyamide. The prepared composition for aramid was dissolved in 99% sulfuric acid to prepare a 20% by weight of a spinning dope. Subsequently, the spinning dope was spun through a spinneret, passed through an air gap, and coagulated while passing through a coagulation bath containing an aqueous sulfuric acid solution and a coagulation tube disposed at a lower part of the coagulation bath to prepare filaments.

The filaments were washed with water to remove sulfuric acid residue and dried in a drying roll such that the water content of the filaments reached 5% by weight. Then, the dried filaments were wound on the core of a winder to prepare aramid fibers as final products.

### EXAMPLE2

Aramid fibers were prepared in the same manner as in Example 1, except that 9-hydroxyanthracene was used instead of the N-(4-amino-3-methoxy-9,10-dioxoanthracen-1-yl)-4-methylbenzenesulfoamide.

### EXAMPLE3

Aramid fibers were prepared in the same manner as in Example 1, except that 2-hydroxynaphthalene was used instead of the N-(4-amino-3-methoxy-9,10-dioxoanthracen-1-yl)-4-methylbenzenesulfoamide.

### EXAMPLE4

Aramid fibers were prepared in the same manner as in Example 1, except that indole was used instead of the N-(4-amino-3-methoxy-9,10-dioxoanthracen-1-yl)-4-methylbenzenesulfoamide.

### EXAMPLE5

Aramid fibers were prepared in the same manner as in Example 1, except that 2-amino-6-oxypruine was used instead of N-(4-amino-3-methoxy-9,10-dioxoanthracen-1-yl)-4-methylbenzenesulfoamide.

### EXAMPLES 6 AND 7

Aramid fibers were prepared in the same manner as in Example 1, except that the contents of N-(4-amino-3-methoxy-9,10-dioxoanthracen-1-yl)-4-methylbenzenesulfoamide were changed to 0.01% by weight and 10% by weight, based on the weight of the aromatic polyamide, respectively.

### COMPARATIVE EXAMPLES 1 AND 2

Aramid fibers were prepared in the same manner as in Example 1, except that the contents of N-(4-amino-3-methoxy-9,10-dioxoanthracen-1-yl)-4-methylbenzenesulfoamide were changed to 0.005% by weight and 15% by weight, based on the weight of the aromatic polyamide, respectively.

### COMPARATIVE EXAMPLE 3

Aramid fibers were prepared in the same manner as in Example 1, except that a spinning dope containing no N-(4-amino-3-methoxy-9,10-dioxoanthracen-1-yl)-4-methylbenzenesulfoamide was used.

### COMPARATIVE EXAMPLE 4

Aramid fibers were prepared in the same manner as in Example 1, except that polyvinyl alcohol having an average molecular weight of 50,000 to 80,000 was used instead of the N-(4-amino-3-methoxy-9,10-dioxoanthracen-1-yl)-4-methylbenzenesulfoamide.

The tensile strength and elongation of aramid fibers in accordance with Examples and Comparative Examples were measured in accordance with the following method and the results thus obtained are shown in Table 1 below.

Tensile Strength and Elongation of Aramid fibers

The tensile strength and elongation of a aramid fiber were measured in accordance with ASTM D885. Specifically, the tensile strength and elongation of the aramid fiber were measured by stretching the aramid fiber having a length of 25 cm in an Instron testing machine (Instron Engineering Corp, Canton, Mass.) until the aramid fibers broke. At this time, the tensile velocity was 300 mm/min and the initial load was determined by the formula of thickness(denier) × 1/30 g. The tensile strength and elongation were obtained by testing five samples and then averaging the test results.

TABLE 1

| | | Content | | |
|---|---|---|---|---|
| | | of ad- | Tensile | Elon- |
| | | ditive | strength | gation |
| No. | Additive | (wt %) | (g/d) | (%) |
| Ex. 1 | N-(4-amino-3-methoxy-9,10-di- | 1 | 34 | 3.9 |
| | oxoanthracen-1-yl)-4-methyl- | | | |
| | benzenesulfoamide | | | |
| Ex. 2 | 9-Hydroxyanthracene | 1 | 31 | 3.7 |
| Ex. 3 | 9-Hydroxynaphthalene | 1 | 32 | 3.8 |
| Ex. 4 | Indole | 1 | 29 | 3.5 |
| Ex. 5 | 2-Amino-6-oxypruine | 1 | 28 | 3.5 |
| Ex. 6 | N-(4-amino-3-methoxy-9,10-di- | 0.01 | 29 | 3.5 |
| | oxoanthracen-1-yl)-4-methyl- | | | |
| | benzenesulfoamide | | | |
| Ex. 7 | N-(4-amino-3-methoxy-9,10-di- | 10 | 28 | 3.5 |
| | oxoanthracen-1-yl)-4-methyl- | | | |
| | benzenesulfoamidehylbenzene- | | | |
| | sulfoamide | | | |
| Comp. | N-(4-amino-3-methoxy-9,10-di- | 0.005 | 24 | 3.3 |
| Ex. 1 | oxoanthracen-1-yl)-4-methyl- | | | |
| | benzenesulfoamide | | | |
| Comp. | N-(4-amino-3-methoxy-9,10-di- | 15 | 24 | 3.4 |
| Ex. 2 | oxoanthracen-1-yl)-4-methyl- | | | |
| | benzenesulfoamide | | | |
| Comp. | — | — | 23 | 3.2 |
| Ex. 3 | | | | |
| Comp. | PVA | 1 | 21 | 3.1 |
| Ex. 4 | | | | |

As can be seen from Table 1 above, the aramid fibers prepared using the composition for aramid obtained by adding a fused aromatic compound to aromatic polyamide exhibited superior tensile strength and elongation, as compared to the fibers of Comparative Example 3 and Comparative Example 4 containing no fused aromatic compound.

The effects of the contents of fused aromatic compounds on the tensile strength and elongation of aromatic polyamide fibers can be explained referring to the Examples 1, 6 and 7, and Comparative Examples 1 and 2. Generally, as the content of fused aromatic compound increased, tensile strength and elongation of an aramid fiber increased. when the content of the fused aromatic compound exceeds a predetermined level, however, the tensile strength and elongation of an aramid fiber decreases again. That is, it could be seen that the content of fused aromatic compound should be 0.01 to 10% by weight, based on the weight of the aromatic polyamide, in order to impart a tensile strength of 28 g/d or more and an elongation of 3.5% or more to the aramid fibers. In order words, it is desirable that the content of fused aromatic compound is 0.01 to 10 parts by weight, based on 100 parts by weight of aromatic polyamide.

1. A composition for aramid comprising:
aromatic polyamide; and
a fused aromatic compound,
wherein the content of the fused aromatic compound is 0.01 to 10 parts by weight, based on 100 parts by weight of the aromatic polyamide.

2. The composition for aramid according to claim 1, wherein the fused aromatic compound has 2 to 10 fused rings.

3. The composition for aramid according to claim 1, wherein the fused aromatic compound comprises at least one of a fused polycyclic aromatic compound and a fused heteropolycyclic aromatic compound.

4. The composition for aramid according to claim 1, wherein the fused aromatic compound comprises at least one of naphthalene, anthracene, phenanthrene, and derivatives thereof.

5. The composition for aramid according to claim 1, wherein the fused aromatic compound comprises at least one of quinoline, isoquinoline, indole, purine, porphyrin, and derivatives thereof.

6. The composition for aramid according to claim 1, wherein the fused aromatic compound contains a functional group capable of forming a hydrogen bond with the aromatic polyamide.

7. The composition for aramid according to claim 6, wherein the functional group is selected from the group consisting of —COOH, —NH₂, —OH, —SO₃H, —SO₂NH₂, —CONH₂, —SH, and aromatic or aliphatic derivatives containing —O—, —NH—, or —S—.

8. The composition for aramid according to claim 1, wherein the fused aromatic compound comprises a dioxoanthracene derivative represented by the following formula 1: 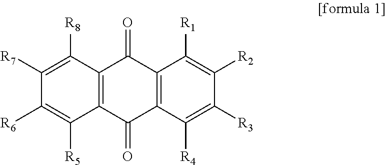
wherein each of R1 to R8 is independently a hydrogen atom, a substituted or unsubstituted alkyl group, a substituted or unsubstituted aryl group, a substituted or unsubstituted heterocyclic group, or a functional group capable of forming a hydrogen bond with the aromatic polyamide.

9. The composition for aramid according to claim 8, wherein at least one of R1 to R8 is the functional group, and the functional group is selected from the group consisting of —COOH, —NH₂, —OH, —SO₃H, —SO₂NH₂, —CONH₂, —SH, and aromatic or aliphatic derivatives containing —O—, —NH—, or —S—.

10. The composition for aramid according to claim 1, wherein the aromatic polyamide is para-aromatic polyamide.

11. An aramid product comprising:
aromatic polyamide; and
a fused aromatic compound dispersed in the aromatic polyamide,
wherein the content of the fused aromatic compound is 0.01 to 10 parts by weight, based on 100 parts by weight of the aromatic polyamide.

12. The aramid product according to claim 11, wherein the aramid product is a fiber and the fiber has a tensile strength of 28 to 35 g/d and an elongation of 3.5 to 4.0%.

13. The aramid product according to claim 11, wherein the aramid product has a film, sheet, rod or spherical shape.
